(19) United States
(12) Patent Application Publication
(10) Pub. No.: US 2023/0173743 A1
(43) Pub. Date: Jun. 8, 2023

(54) BIO PRINTER CAPABLE OF AUTO-LEVELING AND AUTOLEVELING METHOD THEREOF

(71) Applicant: ROKIT HEALTHCARE INC., Seoul (KR)

(72) Inventor: Seok Hwan You, Seoul (KR)

(21) Appl. No.: 17/823,215

(22) Filed: Aug. 30, 2022

(30) Foreign Application Priority Data
Dec. 3, 2021 (KR) 10-2021-0171688

(51) Int. Cl. B29C 64/10; B29C 64/393

(52) U.S. Cl. CPC B29C 64/10; B29C 64/393

(57) ABSTRACT

The present disclosure relates to a bio printer capable of auto-leveling and an auto-leveling method thereof. The bio printer may include: at least one dispenser configured to discharge a biomaterial inside a printing chamber; a printing plate module disposed below the dispenser for the discharged biomaterial to be placed thereon; a sensor housing coupled to a lateral portion of the printing plate module and having an opening formed in an upper surface; a non-contact type leveling sensor provided on a lower side of the opening in an inner space of the sensor housing and configured to detect a nozzle of the dispenser; and a controller configured to control movement of the dispenser or the printing plate module, wherein the controller controls the movement of the dispenser or the printing plate module so that the leveling sensor measures a position of a tip of the nozzle of the dispenser.

### CROSS-REFERENCE TO RELATED APPLICATION

This application claims priority to and the benefit of Korean Patent Application No. 2021-0171688, filed on Dec. 3, 2021, the disclosure of which is incorporated herein by reference in its entirety.

### BACKGROUND

### 1. Field of the Invention

The present disclosure relates to a bio printer capable of auto-leveling and an auto-leveling method thereof that can automatically level heights of a dispenser nozzle through which a biomaterial is discharged and a printing surface on which the biomaterial is mounted, in the bio printer.

### 2. Discussion of Related Art

In recent years, with an increase in the number of research fields in tissue engineering and regenerative medicine and demands for customized medical services, research on 3D printers using biomaterials has been actively carried out.

A known 3D printer includes a frame constituting X-, Y-, and Z-axes and a nozzle for discharge of a biomaterial. In the conventional printer, a liquid dispenser is filled with a viscous fluid biomaterial such as collagen or gelatin. The fluid biomaterial with which the liquid dispenser is filled is discharged to a printing plate through a nozzle.

However, in a case in which the biomaterial is in a solid state instead of a fluid state, the nozzle should be heated to a high temperature to discharge the biomaterial in a flowable state. Therefore, in order to use a fluid biomaterial and a solid biomaterial together, a process of heating and cooling the nozzle is repeated, and thus the nozzle is overloaded.

In order to address this, Korean Patent Registration No. 10-1828345 discloses a 3D bio printer including a first dispenser configured to melt and discharge a solid biomaterial for forming a scaffold and other structures and a second dispenser configured to print a fluid biomaterial.

Nozzles of the first and second dispensers may be manufactured in various lengths and applied to be detachable and replaceable, and in this case, a distance from a printing surface to a tip of the nozzle during printing may vary according to the lengths of the nozzles of the first and second dispensers.

Thus, there is a demand for a device that automatically levels heights of a dispenser nozzle through which a biomaterial is discharged and a printing surface on which the biomaterial is mounted, in a bio printer, so that a biomaterial can be discharged at a constant predetermined height from the printing surface even when lengths of nozzles of first and second dispensers change.

### RELATED ART DOCUMENT

### Patent Document

(Patent Document 1) Korean Patent Registration No. 10-1828345 (Date of Publication: Mar. 29, 2018)

### SUMMARY OF THE INVENTION

The present disclosure is directed to providing a bio printer capable of autoleveling and an auto-leveling method thereof allowing a biomaterial to be discharged at a constant predetermined height from a printing surface even when a length of a dispenser nozzle changes.

A first aspect of the present disclosure relates to a bio printer capable of autoleveling. The bio printer may include: at least one dispenser configured to discharge a biomaterial inside a printing chamber; a printing plate module disposed below the dispenser for the discharged biomaterial to be placed thereon; a sensor housing coupled to a lateral portion of the printing plate module and having an opening formed in an upper surface; a non-contact type leveling sensor provided on a lower side of the opening in an inner space of the sensor housing and configured to detect a nozzle of the dispenser; and a controller configured to control movement of the dispenser or the printing plate module, wherein the controller controls the movement of the dispenser or the printing plate module so that the leveling sensor measures a position of a tip of the nozzle of the dispenser.

According to an embodiment of the present disclosure, the leveling sensor may be a laser sensor, and the leveling sensor may be installed on one sidewall of the inner space of the sensor housing and emit laser toward the other sidewall to detect the nozzle of the dispenser.

According to an embodiment of the present disclosure, the dispenser may consist of at least any one of a first dispenser whose nozzle end portion is formed to be tapered toward the tip of the nozzle and a second dispenser whose nozzle end portion is formed in a linear shape.

According to an embodiment of the present disclosure, the controller may move the dispenser or the printing plate module so that the tip of the nozzle of the dispenser is placed above the opening of the sensor housing, may move the dispenser downward so that the tip of the nozzle of the dispenser is placed below a height of the leveling sensor past the opening of the sensor housing, may move the dispenser or the printing plate module horizontally until the nozzle of the dispenser is detected, may move the nozzle of the dispenser upward a predetermined distance at a time until the nozzle of the dispenser is not detected, and may further move the dispenser or the printing plate module horizontally, and the leveling sensor, in a case in which the nozzle of the dispenser is not detected, may measure a position of the tip of the nozzle of the dispenser at a position at which the nozzle of the dispenser was last detected, and in a case in which the nozzle of the dispenser is detected, may repeat moving the nozzle of the dispenser upward and further moving the dispenser or the printing plate module horizontally until the nozzle of the dispenser is not detected anymore, and then measure the position of the tip of the nozzle of the dispenser at the position at which the nozzle of the dispenser was last detected.

According to an embodiment of the present disclosure, the bio printer may further include a calculator configured to calculate a downward movement distance of the dispenser during printing by reflecting the measured position of the tip of the nozzle of the dispenser and a distance between the leveling sensor and a printing surface of the printing plate module.

A second aspect of the present disclosure relates to an auto-leveling method of a bio printer. The method, which is an auto-leveling method performed by a bio printer including a dispenser, a printing plate module, a non-contact type leveling sensor installed at a lateral portion of the printing plate module, and a controller, may include: (a) an operation of, by the controller, moving the dispenser downward so that a tip of a nozzle of the dispenser is placed below a height of the leveling sensor; (b) an operation of, by the controller, moving the dispenser or the printing plate module horizontally until the nozzle of the dispenser is detected; (c) an operation of, by the controller, moving the nozzle of the dispenser upward a predetermined distance at a time until the nozzle of the dispenser is not detected; and (d) an operation of, by the controller, further moving the dispenser or the printing plate module horizontally, wherein step (d) may include, by the leveling sensor, in a case in which the nozzle of the dispenser is not detected, measuring a position of the tip of the nozzle of the dispenser at a position at which the nozzle of the dispenser was last detected, and in a case in which the nozzle of the dispenser is detected, repeating moving the nozzle of the dispenser upward and further moving the dispenser or the printing plate module horizontally until the nozzle of the dispenser is not detected anymore, and then measuring the position of the tip of the nozzle of the dispenser at the position at which the nozzle of the dispenser was last detected.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating a bio printer capable of auto-leveling according to the present disclosure;

FIG. 2 is a view illustrating a state in which an end portion of a nozzle of a dispenser is moved downward into a sensor housing in order to measure a position of a tip of the nozzle of the dispenser of FIG. 1;

FIG. 3 is a view separately illustrating a dispenser nozzle and another dispenser nozzle in FIG. 1;

FIG. 4 is a lateral cross-sectional view of FIG. 3;

FIG. 5A is a view illustrating a state in which a leveling sensor of FIG. 2 has detected a nozzle of a first dispenser discharging a biomaterial, and FIG. 5B is a view illustrating a state in which the leveling sensor of FIG. 2 has detected a nozzle of a second dispenser discharging a bio ink; and

FIG. 6 is a view illustrating a state in which a leveling sensor of FIG. 4 has emitted laser.

### DETAILED DESCRIPTION OF EXEMPLARY EMBODIMENTS

Hereinafter, details for carrying out the present disclosure will be described with reference to the accompanying drawings. In describing the present disclosure, when a related known function is apparent to those of ordinary skill in the art and is deemed as having the possibility of unnecessarily obscuring the gist of the present disclosure, detailed description thereof will be omitted.

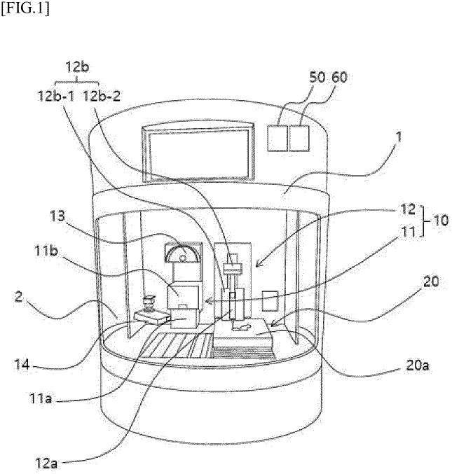

FIG. 1 is a view illustrating a bio printer capable of auto-leveling according to the present disclosure.

Referring to FIG. 1, the bio printer capable of auto-leveling according to the present disclosure includes a printing chamber 1 and a door 2 formed to be openable and closeable on the printing chamber 1, and performs printing of a biomaterial in an inner space closed by the door 2.

The bio printer includes a dispenser 10, a printing plate module 20, a sensor housing 30, a leveling sensor 40, a controller 50, and a calculator 60.

The dispenser 10 is provided as one or more dispensers 10 and is formed to discharge a biomaterial through a nozzle and be movable upward, downward, leftward, and rightward. The dispenser 10 may include a first discharge module 10a and a second discharge module 10b on which the first discharge module is detachably mounted. The dispenser 10 may be made of at least any one of a first dispenser 11 whose nozzle end portion is formed to be tapered toward a tip of the nozzle and a second dispenser 12 whose nozzle end portion is formed in a linear shape or formed to be tapered.

The first dispenser 11 melts and discharges a solid biomaterial. A biomaterial holder 13 around which a biomaterial is wound is provided at an upper side of the first dispenser 11. The biomaterial may be made of a biomaterial to which a granular melting method using pneumatic pressure is applied or may be made of a polycaprolactone (PCL) biomaterial. The solid biomaterial discharged from the first dispenser 11 forms a scaffold. The biomaterial wound around the biomaterial holder 13 is provided to the first dispenser 11, heated to a predetermined temperature in the first dispenser 11, and then discharged through a nozzle. The first dispenser 11 is made of a 1-1 discharge module 11a and a 1-2 discharge module 11b. The nozzle is mounted on an end portion of the 1-1 discharge module 11a, and the 1-1 discharge module 11a is detachably mounted on the 1-2 discharge module 11b. A cooling fan 14 configured to cool down the biomaterial discharged from the first dispenser 11 may be disposed at a lateral portion of the nozzle of the first dispenser 11.

The second dispenser 12 discharges a liquid bio ink. The second dispenser 12 is made of a 2-1 discharge module 12a and a 2-2 discharge module 12b. The 2-1 discharge module 12a is formed in the shape of a syringe and has a nozzle mounted on an end portion. The 2-2 discharge module 12b includes a fixer 12b-1 configured to fix the syringe, and a presser 12b-2 configured to receive power from a pneumatic pressure provider (not illustrated) or a step motor (not illustrated) and press a pressure bar of the syringe to discharge the bio ink in the syringe.

The printing plate module 20 is disposed below the dispenser 10, has a printing surface 20a on which the discharged biomaterial is placed, and is formed to be fixed or formed to be movable on a horizontal plane. The biomaterial discharged from the dispenser 10 is placed on the printing surface 20a. The printing plate module 20 may include, from top to bottom, a film 21, a matrix plate 22, a cooling bed 23, a support plate 25 on which a Peltier element 24 is placed, and a water block 26 (see FIG. 6). The film 21 is detachably attached to an upper surface of the matrix plate 22, and in this case, an upper surface of the film 21 is the printing surface 20a. The film 21 may be made of a polyurethane material. The film 21 is easily adhered to a molten polymer material and prevents the liquid bio ink from leaking from the scaffold. As the film 21 partially melts due to the biomaterial printed by the first dispenser 11, the scaffold is fusion-fixed to the film 21. Accordingly, the fluid biomaterial printed by the second dispenser 12 does not leak through an interface between the scaffold and the film 21. The output formed of the scaffold and the fluid biomaterial and freeze-hardened may be configured as a patch implanted in an affected area of skin. Also, the affected area may be an affected area where a diabetic foot ulcer has occurred,

The matrix plate 22 is detachably mounted on the cooling bed 23. The cooling bed 23 is disposed on the Peltier element 24 and cooled by the Peltier element 24. The water block 26 is provided at a heating surface side, which is a lower surface side, of the Peltier element 24, and a coolant flow path (not illustrated) in which a coolant for dissipating heat generated from the Peltier element 24 circulates is formed in the water block 26. The water block 26 may be formed of brass and/or aluminum having high thermal conductivity.

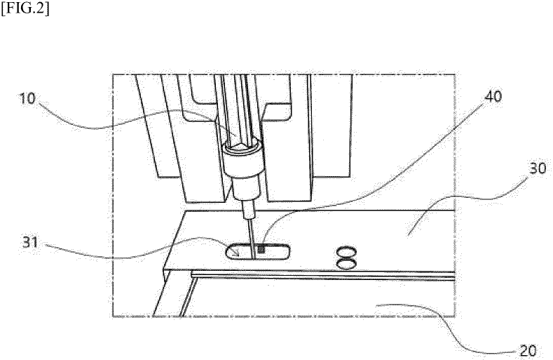

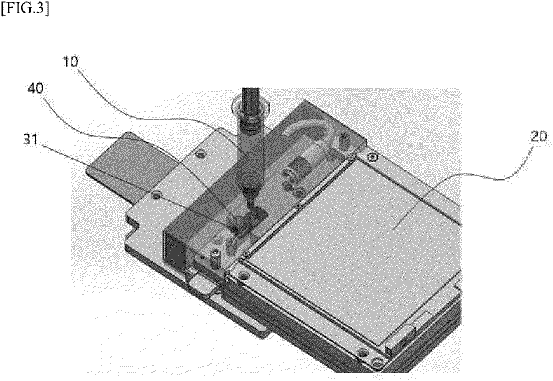

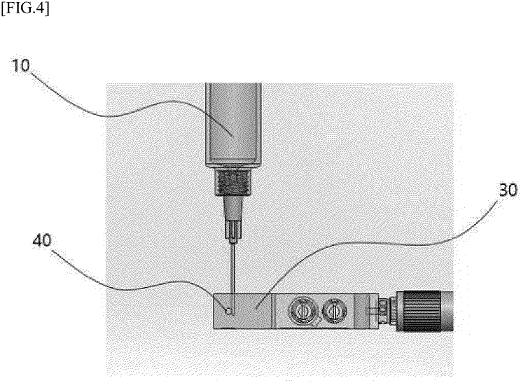

FIG. 2 is a view illustrating a state in which an end portion of a nozzle of a dispenser is moved downward into a sensor housing in order to measure a position of a tip of the nozzle of the dispenser of FIG. 1. FIG. 3 is a view separately illustrating a dispenser nozzle and another dispenser nozzle in FIG. 1. FIG. 4 is a lateral cross-sectional view of FIG. 3.

Referring to FIGS. 2 to 4, the sensor housing 30 is coupled to a lateral portion of the printing plate module 20 and has an opening 31 formed in an upper surface. An inner space which opens upward through the opening 31 is formed in the sensor housing 30. The leveling sensor 40 is a non-contact type and is provided on a lower side of the opening 31 in the inner space of the sensor housing 30 and detects a nozzle of the dispenser 10. The leveling sensor 40 may be a laser sensor. The leveling sensor 40 is installed on one of two sidewalls of the sensor housing 30 that face each other. The leveling sensor 40 installed on the one sidewall may emit laser toward the other sidewall to detect the nozzle of the dispenser 10.

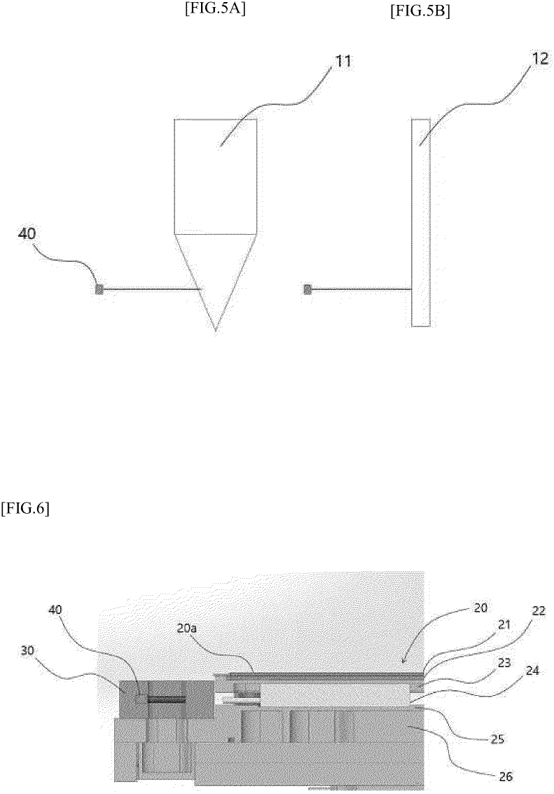

FIG. 5A is a view illustrating a state in which a leveling sensor of FIG. 2 has detected a nozzle of a first dispenser discharging a biomaterial, and FIG. 5B is a view illustrating a state in which the leveling sensor of FIG. 2 has detected a nozzle of a second dispenser discharging a bio ink.

An auto-leveling method of the bio printer according to the present disclosure will be described below with reference to FIGS. 5A and 5B.

The controller 50 controls movement of the dispenser 10 and/or the printing plate module 20. The controller 50 may control the movement of the dispenser 10 and/or the printing plate module 20 so that the leveling sensor 40 measures a position of a tip of the nozzle of the dispenser 10. The steps of the auto-leveling method according to the present disclosure are as follows.

The controller 50 moves the dispenser 10 and/or the printing plate module 20 so that the tip of the nozzle of the dispenser 10 is placed above the opening 31 of the sensor housing 30 (S10). The controller 50 moves the dispenser 10 downward so that the tip of the nozzle of the dispenser 10 is placed below a height of the leveling sensor 40 past the opening of the sensor housing 30 (S20). The controller 50 moves the dispenser 10 and/or the printing plate module 20 horizontally until the nozzle of the dispenser 10 is detected (S30). The controller 50 moves the nozzle of the dispenser 10 upward a predetermined distance at a time until the nozzle of the dispenser 10 is not detected (S40). The controller 50 further moves the dispenser 10 and/or the printing plate module 20 horizontally, and in cases in which the nozzle of the dispenser 10 is and is not detected, measurement methods of the leveling sensor 40 are as follows.

The leveling sensor 40 measures a position of the tip of the nozzle of the dispenser 10 at a position at which the nozzle of the dispenser 10 was last detected in the case in which the nozzle of the dispenser 10 is not detected. On the other hand, the leveling sensor 40 repeats moving the nozzle of the dispenser 10 upward and further moving the dispenser 10 and/or the printing plate module 20 horizontally until the nozzle of the dispenser 10 is not detected anymore, and then measures the position of the tip of the nozzle of the dispenser 10 at the position at which the nozzle of the dispenser 10 was last detected in the case in which the nozzle of the dispenser 10 is detected.

The calculator 60 may calculate a downward movement distance of the dispenser 10 during printing by reflecting the measured position of the tip of the nozzle of the dispenser 10 and a distance 1 between the leveling sensor 40 and the printing surface of the printing plate module 20. For example, the calculator 60 may calculate an offset value for auto-leveling by adding or subtracting the distance 1 to or from a distance from an initial position of the nozzle of the dispenser 10 to a position of the tip of the nozzle measured by the leveling sensor 40.

The auto-leveling method may be identically applied to the first dispenser 11 and the second dispenser 12. That is, regardless of the type of dispenser, whether it is the first dispenser 11 whose nozzle end portion is formed to be tapered or the second dispenser 12 whose nozzle end portion is formed in a linear shape, the auto-leveling method may be identically applied, and a position of a tip of a nozzle of the dispenser can be accurately determined during printing.

According to the present disclosure, a biomaterial can be discharged at a constant predetermined height from a printing surface even when a length of a dispenser nozzle changes.

The protection scope of the present disclosure is not limited by the description or expressions of the embodiments explicitly described above. Also, it should be noted that changes or substitutions self-evident in the art to which the present disclosure pertains cannot limit the protection scope of the present disclosure.

What is claimed is:

1. A bio printer capable of auto-leveling, the bio printer comprising:
at least one dispenser configured to discharge a biomaterial inside a printing chamber;
a printing plate module disposed below the dispenser for the discharged biomaterial to be placed thereon;
a sensor housing coupled to a lateral portion of the printing plate module and having an opening formed in an upper surface;
a non-contact type leveling sensor provided on a lower side of the opening in an inner space of the sensor housing and configured to detect a nozzle of the dispenser; and
a controller configured to control movement of the dispenser or the printing plate module,
wherein the controller controls the movement of the dispenser or the printing plate module so that the leveling sensor measures a position of a tip of the nozzle of the dispenser.

2. The bio printer of claim 1, wherein:
the leveling sensor is a laser sensor; and
the leveling sensor is installed on one sidewall of the inner space of the sensor housing and emits laser toward the other sidewall to detect the nozzle of the dispenser.

3. The bio printer of claim 1, wherein the dispenser consists of at least any one of a first dispenser whose nozzle end portion is formed to be tapered toward the tip of the nozzle and a second dispenser whose nozzle end portion is formed in a linear shape.

4. The bio printer of claim 1, wherein the controller:
moves the dispenser or the printing plate module so that the tip of the nozzle of the dispenser is placed above the opening of the sensor housing;
moves the dispenser downward so that the tip of the nozzle of the dispenser is placed below a height of the leveling sensor past the opening of the sensor housing;
moves the dispenser or the printing plate module horizontally until the nozzle of the dispenser is detected;
moves the nozzle of the dispenser upward a predetermined distance at a time until the nozzle of the dispenser is not detected; and
further moves the dispenser or the printing plate module horizontally, and
the leveling sensor, in a case in which the nozzle of the dispenser is not detected, measures a position of the tip of the nozzle of the dispenser at a position at which the nozzle of the dispenser was last detected, and in a case in which the nozzle of the dispenser is detected, repeats moving the nozzle of the dispenser upward and further moving the dispenser or the printing plate module horizontally until the nozzle of the dispenser is not detected anymore, and then measures the position of the tip of the nozzle of the dispenser at the position at which the nozzle of the dispenser was last detected.

5. The bio printer of claim 1, further comprising a calculator configured to calculate a downward movement distance of the dispenser during printing by reflecting the measured position of the tip of the nozzle of the dispenser and a distance between the leveling sensor and a printing surface of the printing plate module.

6. An auto-leveling method of a bio printer, which is an auto-leveling method performed by a bio printer including a dispenser, a printing plate module, a non-contact type leveling sensor installed at a lateral portion of the printing plate module, and a controller, the auto-leveling method comprising:
(a) an operation of, by the controller, moving the dispenser downward so that a tip of a nozzle of the dispenser is placed below a height of the leveling sensor;
(b) an operation of, by the controller, moving the dispenser or the printing plate module horizontally until the nozzle of the dispenser is detected;
(c) an operation of, by the controller, moving the nozzle of the dispenser upward a predetermined distance at a time until the nozzle of the dispenser is not detected; and
(d) an operation of, by the controller, further moving the dispenser or the printing plate module horizontally,
wherein step (d) includes, by the leveling sensor, in a case in which the nozzle of the dispenser is not detected, measuring a position of the tip of the nozzle of the dispenser at a position at which the nozzle of the dispenser was last detected, and in a case in which the nozzle of the dispenser is detected, repeating moving the nozzle of the dispenser upward and further moving the dispenser or the printing plate module horizontally until the nozzle of the dispenser is not detected anymore, and then measuring the position of the tip of the nozzle of the dispenser at the position at which the nozzle of the dispenser was last detected.
